(19) United States
(12) Patent Application Publication
(10) Pub. No.: US 2003/0043979 A1
(43) Pub. Date: Mar. 6, 2003

(54) Method and apparatus for downloading "on-hold" messages for telephone systems

(76) Inventor: Michael D. Smith, Howell, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/233,689

(22) Filed: Sep. 3, 2002

Related U.S. Application Data
(60) Provisional application No. 60/317,010, filed on Sep. 4, 2001.

(51) Int. Cl. H04M 1/64; G06F 15/177

(52) U.S. Cl. 379/88.22; 709/221

(57) ABSTRACT

A system for providing a single on-hold audio message to a plurality of business telephone systems at separated geographic locations converts the audio message into digital form, compresses the resulting digital file, and transmits the file via the Internet as an attachment to an e-mail message to general purpose computers located in association with each of the business telephone systems. Each of the general purpose computers receiving the message writes it onto a floppy disc which is provided to an associated playback unit. The playback units read the compressed digital files representing the on-hold message, provide the recirculating flash memories, provide the output of the flash memories to decompressors and the output of the decompressors to digital-to-analog converters. The resulting audio signals are applied to the on-hold inputs of each of the business telephone systems.

### BACKGROUND OF THE INVENTION

### CROSS-REFERENCE TO RELATED APPLICATION

The present application is based upon U.S. Provisional Serial No. 60/317,010, filed Sep. 4, 2001, for a System and Apparatus for Downloading “On Hold” Messages for Telephone System.

### FIELD OF THE INVENTION

This invention is directed toward a system and a method for providing on-hold audio messages to a plurality of geographically dispersed business telephone systems through transmission of a single e-mail message from a central location to general purpose computers at each of the telephone systems, with the audio message in compressed digital form as an attachment to the e-mail message.

### BACKGROUND OF THE INVENTION

It is often desirable to change the on-hold message that is played to persons who telephone a business while they wait to be connected. A retail chain having a number of locations may want to change the on-hold message that is played at all of the locations to announce the release of a new product, new service or a sale. At the present time, this is done by recording tape cassettes or compact discs at a central location and delivering them to each of the retail locations. They are then placed in playback units which repeatedly generate the message in audio form for provision to the on-hold inputs of associated business telephone systems. The system of this type is disclosed in Hazenfield Patent No. 6,272,211.

Another Hazenfield patent, No. 5,991,374, discloses a system where a list of available on-hold messages is maintained at a central computer server and general purpose computers that are associated with business telephone systems at a number of remote locations can communicate with the server to obtain a list of available messages and to order individual messages. These systems are not amenable to the simple, low-cost transmission of an individual message to a plurality of business telephone systems simultaneously which is desirable in modem business systems where it is necessary that the on-hold message be frequently changed.

### SUMMARY OF THE INVENTION

The present invention is directed toward a method and system which allows low-cost, convenient, simultaneous transfer of new on-hold messages to a plurality of geographically dispersed business telephone systems. Broadly, the present invention involves the generation of a compressed digital file representing an on-hold message at a central location and the transmission of that file to computers associated with each of the dispersed telephone systems as an attachment to a single e-mail message. Each of the computers receiving the message writes the compressed digital file onto a floppy disc which is manually inserted into a floppy disc reader in an associated playback unit. The playback unit operates under the control of a microprocessor to read the compressed digital file into a recirculating flash memory, the output of the memory thus continuously generates a compressed digital output representing the on-hold message, which is provided first to a decompressor and then to a digital-to-analog converter connected to the output of the playback unit. Thus, a decompressed audio version of the on-hold message is continually repeated at the output of the playback unit. The output of the playback unit is connected by a cable to the on-hold input of a business telephone system so that the message is provided to callers to the telephone system while they are on hold.

The system is low-cost, employs largely readily available equipment and is extremely flexible in operation.

### DETAILED DESCRIPTION OF THE DRAWINGS

Other objects, advantages and applications of the present invention will be made apparent by the following detailed description of the preferred embodiment of the invention. The description makes reference to the accompanying drawings in which:

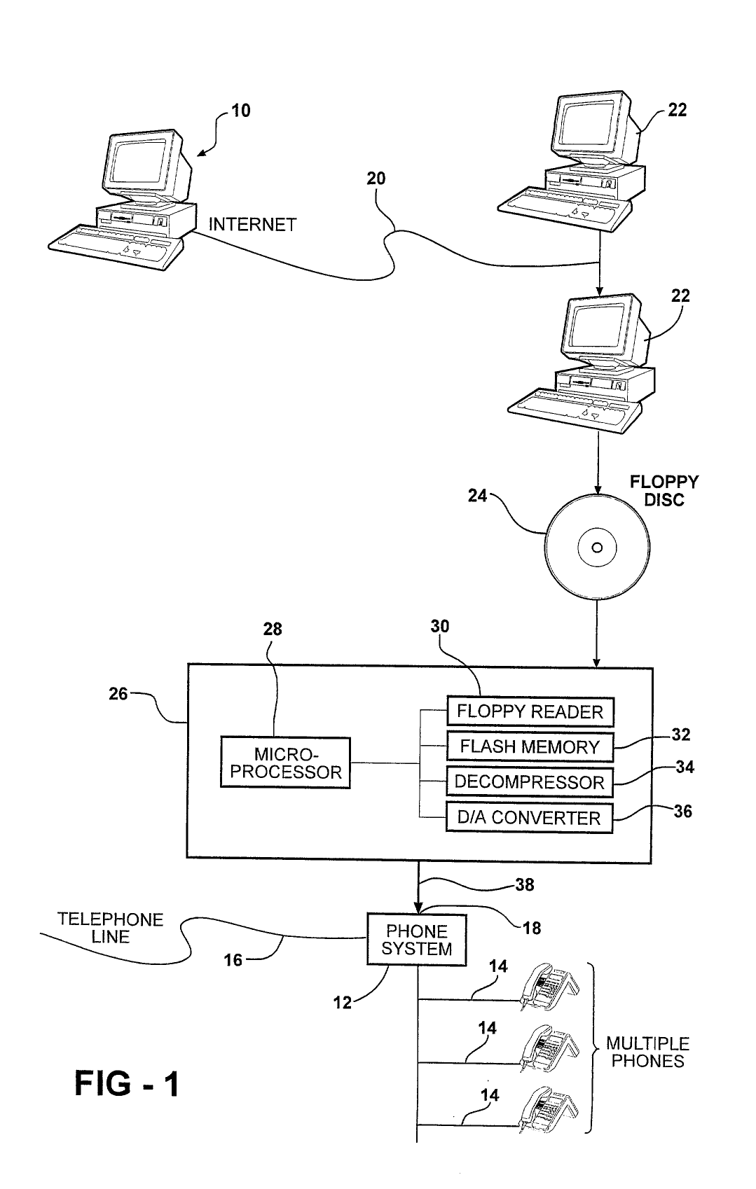

FIG. 1 represents a schematic diagram illustrating the arrangement of the system including the playback unit; and

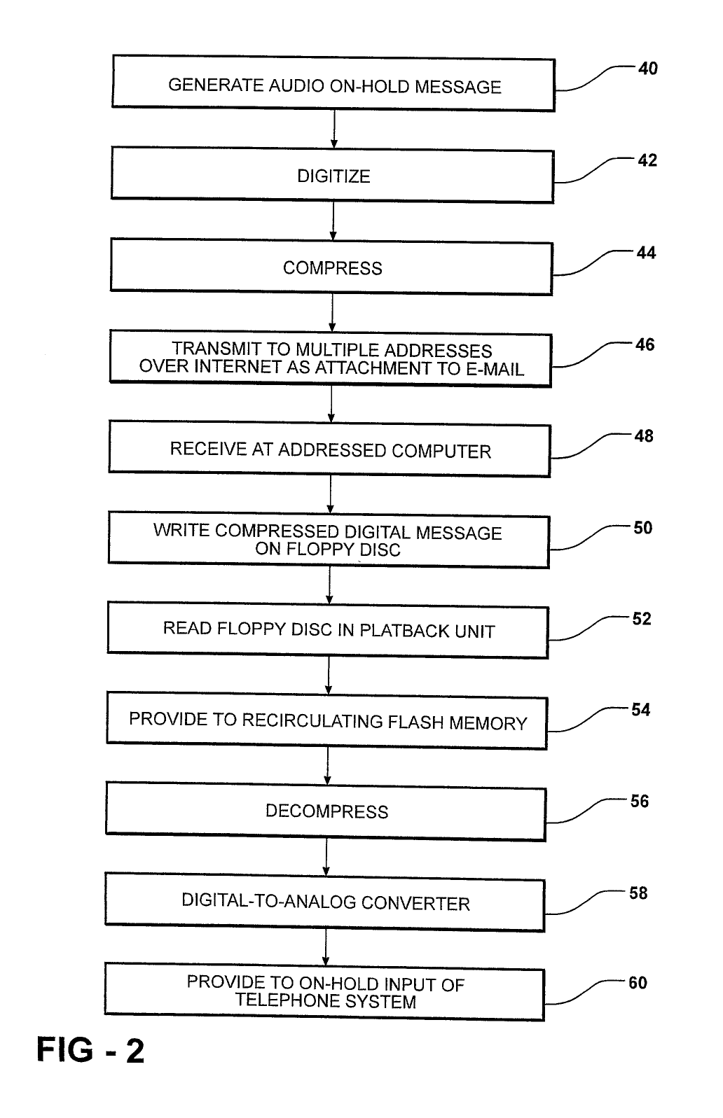

FIG. 2 is a flow chart representing the steps in the process of the preferred embodiment.

### DETAILED DESCRIPTION OF THE PREFERRED EMBODIMENT

Referring to FIG. 1, a system of the present invention operates to transmit the desired on-hold audio message from a central location equipped with a computer 10, which may be a server or a personal computer, to a plurality of business telephone systems 12, only one of which is illustrated in FIG. 1, of the type servicing multiple individual telephones 14 and multiple connecting telephone lines 16. Business telephone systems 12 used with the present invention of the type that have on-hold input 18 adapted to receive an audio message to be played to telephones connected to the system while they are on hold. These are commonly available in business establishments at the present time.

The central computer 10 must have a connection to the Internet 20 and must have the capability of digitizing and compressing an input audio message to create a file which is transmitted as an attachment to an e-mail message. Accordingly, the computer 10 must have application programs for digitizing an audio file, compressing the digitized file, and for transmitting e-mail messages with attachments. Using commonly available e-mail programs, a single message with the attachment may be transmitted to a plurality of locations simultaneously.

FIG. 1 illustrates a pair of personal computers or servers 20 which are representative of any number of addressees of an e-mail message sent by the central computer 10 with the on-hold message as an attachment. In addition to being equipped with Internet connection and e-mail program, the addressed computers 10, each of which is associated with an individual business phone system 12 at diverse locations, is equipped with a floppy disc writer so that the on-hold message received as an attachment to the e-mail message from the central computer 10 may be written onto a floppy disc 24. FIG. 1 illustrates a single floppy disc 24, but each of the addressed computers of the system will generate its own floppy disc. Each floppy disc 24 thus contains a digitized, compressed file representing the desired on-hold message. Each floppy disc is provided to a stand-alone playback unit 26, one of which is associated with each business telephone system 12 of the present invention. Each playback unit 26 is controlled by a microprocessor 28. The microprocessor controls a floppy reader 30 adapted to accept and play the floppy disc 24. The compressed, digital file outputted by the floppy reader is provided, under control of the microprocessor 28, to a recirculating flash memory 32. The memory continually outputs repeated compressed digital versions of the desired on-hold message to a decompressor 34. The decompressor generates an uncompressed digital signal representative of the on-hold message which is provided to a digital-to-analog converter 36. The output of the digital-to-analog converter represents the output of the playback unit 26, an audio version of the on-hold message played in recurring form, and is connected by a cable 38 to the on-hold input 18 of the associated business telephone system 12. The message transmitted by the central computer 10 is thus provided to users of the telephone system 12 while they are on hold.

The time from receipt of a new on-hold message 10 until provision of that message to the users of an associated telephone system 12 is only a few minutes. The cost of the transmission process is negligible.

FIG. 2 represents a flow chart illustrating the process. At block 40, representing the input of the system, the audio on-hold message is generated. This will involve the “production” process and is performed in a conventional manner. The audio message is then provided to the central computer 10 where it is digitized at block 42. It is then compressed at block 44 and the computer 10 transmits the digitized compressed on-hold message to the addressee computers 22 at each of the locations which are to play the message on their business telephone system. This illustrated at block 46. Block 48 indicates the reception of the e-mail message with the digitized compressed on-hold message as an attachment at block 48. Each computer receiving the message is controlled to write the message on a floppy disc 24, as illustrated at block 50. The next step in the process, illustrated at block 52, is inserting the floppy disc in the floppy disc reader 30 of the associated playback unit 26. The playback unit provides the on-hold message to the recirculating flash memory 32 as illustrated in block 54. The flash memory continually plays and replays the message, and its output is decompressed at block 56, by the decompressor 34. The output of the decompressor 34 is provided to the digital-to-analog converter 36 which converts the recirculating digital message to analog form as illustrated in block 58. It is then provided to the on-hold input 18 of the telephone system 12 as illustrated in block 60.

Having thus described my invention, I claim:

1. A system for providing an “on-hold” message to a business telephone system having an on-hold input, comprising a first general purpose computer loaded with a first application program for transmitting e-mail messages over an Internet connection and a second application program operative to digitize and compress an audio file; a second general purpose computer having an application program for receiving e-mail messages and an associated floppy disc writer; an Internet connection connecting said first general purpose computer to the said second general purpose computer; a playback unit comprising a floppy disc reader, a recirculating flash memory, a decompressor, a digital-to-analog converter, and a microprocessor-based controller operative to provide audio messages in digital form encoded on a floppy disc disposed in the floppy disc reader to the recirculating flash memory, provide the output of the recirculating flash memory to the decompressor, provide the output of the compressor to the digital-to-analog converter; and a business telephone system having an on-hold audio input adapted to be connected to the output of said digital-to-analog converter of said playback unit so as to provide the audio message in recirculating form to telephones connected to the phone system when they are placed on hold; whereby an audio message to be provided to said business telephone system may be generated in said first general purpose computer, transmitted by said first general purpose computer to said second general purpose computer, via the Internet, as an e-mail message with said digital compressor audio message as an attachment, recorded by said second general purpose computer onto said floppy disc which is provided to the floppy disc reader of the playback unit which retrieves the on-hold message stored in the floppy reader, provides it to the flash memory, provides the output of the flash memory to the decompressor and the output of the decompressor to the digital-to-analog converter so as to repeatedly provide the on-hold message in audio form to the on-hold input telephone system.

2. The system of claim 1 in which a plurality of second general purpose computers, each connected to a separate playback unit and a separate business telephone system are provided, whereby an on-hold message may be simultaneously provided to said plurality of said business telephone systems by addressing said e-mail message to all of said second general purpose computers simultaneously.

3. The system of claim 1, wherein said playback unit is a stand-alone system having a cable interconnecting the output of the digital-to-analog converter to the on-hold audio input of said business telephone system.

4. A playback unit adapted to receive a floppy disc encoded with a digital on-hold message and to provide an audio output consisting of the on-hold message played in recurring form, suitable for provision to the on-hold input of a business telephone system, comprising:
a floppy disc player and reader;
a recirculating flash memory;
a digital decompressor;
a digital-to-analog converter; and
a microprocessor connected to the floppy disc reader and player, the flash memory, the decompressor, and the digital-to-analog converter and operative to control the system to read a compressed digital file representing an on-hold message from a floppy disc and provide it to the flash memory, control the flash memory so as to continually generate the on-hold message in recirculating form at its output, provide the output of the flash memory to a decompressor which converts the compressed on-hold message into a decompressed digital file, provide the output of the decompressor to a digital-to-analog converter which converts the decompressed digital file into an audio file, and provide the audio file in recirculating form at its output to the on-hold input of a business telephone system.

5. The method of providing a single on-hold message to a plurality of business telephone systems at separated geographic locations, comprising:
generating said on-hold message in digital form;
compressing said on-hold message into a compressed digital file;
transmitting said compressed digital file as an attachment to an e-mail message over the Internet to a plurality of general purpose computers, each associated with one of said business telephone systems, using each of said general purpose computers to write a floppy disc containing said compressed digital file representing the audio message;
providing each of the floppy discs to a separate associated playback unit operative to read the compressed on-hold message from the floppy disc, provide it to a recirculating flash memory, provide the output of the recirculating flash memory to a decompressor, provide the output of the decompressor to a digital-to-analog converter; and
providing the output of each digital-to-analog converter of each playback unit to the on-hold audio input of an associated business telephone system.
